(19) United States
(12) Patent Application Publication
(10) Pub. No.: US 2025/0145467 A1
(43) Pub. Date: May 8, 2025

(54) SYNTHESIS OF SYNTHETIC GRAPHITE FROM EXPANDED POLYSTYRENE

(71) Applicant: Eco Carbon LLC, Bala Cynwyd, PA (US)

(72) Inventors: Dipendu Saha, Claymont, DE (US); Hippolyte A. Grappe, Oak Ridge, TN (US)

(21) Appl. No.: 18/504,203

(22) Filed: Nov. 8, 2023

(51) Int. Cl. C01B 32/205

(52) U.S. Cl. CPC C01B 32/205; C01P 2002/72

(57) ABSTRACT

In the first and second embodiments of the process for synthesizing synthetic graphite from expanded polystyrene (EPS), EPS is sulfonated with a solvent and sulfuric acid to obtain stabilized expanded polystyrene. The stabilized EPS is then graphitized using a catalyst to obtain synthetic graphite. In the second embodiment of the process, the stabilized EPS is carbonized at a predetermined elevated temperature to obtain carbonized EPC, and the carbonized EPS is mixed with a boron catalyst and heated in a furnace to obtain the synthetic graphite.

### FIELD OF THE INVENTION

This invention, in general relates to processing expanded polystyrene to obtain synthetic graphite.

### BACKGROUND

Expanded polystyrene (EPS), for example, Styrofoam® of DDP Specialty Electronic Materials US, Inc., is widely used in various applications, for example, household and industrial applications such as home and appliance insulation, packaging of materials, manufacture of food containers and insulators, in road bank stabilization systems, etc., worldwide. Expanded polystyrene is a single-use plastic with minimum recycling value. Approximately 1% of EPS is recycled, while about 99% of EPS is disposed as solid waste. Expanded polystyrene-based materials account for about 30% of total landfill waste in the United States of America (USA). In USA alone, about 1369 tons of expanded polystyrene is disposed as solid waste every year. EPS is not biodegradable and causes hazardous conditions for both terrestrial and aquatic inhabitants. In the environment, EPS may slightly depolymerize to produce traces of styrene, which is a suspected carcinogen. As about 90% of expanded polystyrene is air, expanded polystyrene is light, voluminous, and inexpensive, thereby making conventional recycling of expanded polystyrene unprofitable and not accepted for recycling by most recycling plants. Therefore, upcycling expanded polystyrene-based products into value-added materials may provide an impetus for recycling EPS, minimizing waste and the use of EPS. The overall value-added proposition of EPS provides two-fold benefits: (a) removal of non-recyclable EPS waste that is a pollutant; and (b) utilization of waste EPS to produce graphite, a value added material.

While some efforts have been made in utilizing waste expanded polystyrene (EPS), for example, in liquefaction of EPS by pyrolysis, limited or no efforts have been made in synthesis of carbon-based materials from expanded polystyrene. The key reason for this is attributed to the fact that unlike most other plastic-based materials, pristine expanded polystyrene yields no char or carbon upon carbonization. Pristine expanded polystyrene refers to expanded polystyrene (EPS) in its original, pure, unmodified, and clean form. Carbonization is a process of heating a carbonaceous material, for example EPS, at about 800° C. at a ramp rate of, for example, about 10° C. per minute, in the absence of air and under a flow of nitrogen gas (N2). Char is the solid, residual carbon material that remains after light gases, for example, hydrocarbon gases and tar, have been driven out or released from combustion of the carbonaceous material.

Applicant's U.S. patent application Ser. No. 18/331,974, filed Sep. 6, 2023, discloses a method of “stabilizing” expanded polystyrene (EPS), where expanded polystyrene (EPS) was sulfonated by concentrated sulfuric acid in an organic solvent. The stabilized expanded polystyrene unexpectedly changed the char yielding behavior of EPS. Carbon molecular sieve and activated carbon were synthesized from stabilized EPS.

Synthetic graphite is a high demand material in today's business environment. Graphite has many applications including anode materials for lithium-ion batteries, electrodes for electric arc furnace, carbon brushes, fuel cells, lubricants, conductive materials, aerospace technology, nuclear reactors, vanadium redox batteries, ceramic armor tiles, electro-consolidation, and for many other applications. Synthetic graphite is more expensive than natural graphite, and has a slightly lower density and electrical conductivity, and a slightly higher porosity. Synthetic graphite finds an application in industries due to the limited availability of natural graphite. In addition, synthetic graphite also possesses more desirable consistency, quality and properties than natural graphite, which helps to increase its demand across the globe. In 2018, 354 thousand tons of graphite were consumed in the US, out of which 294 thousand tons were synthetic graphite. Due to the lack of indigenous supply of natural graphite from graphite mines in the US, the US is the third largest importer of synthetic graphite. The US imported around 70,690 metric tons of synthetic graphite in 2021. Petroleum coke and coal tar pitch are the typical raw materials used for producing synthetic graphite. At present, no other material is commercially employed to produce synthetic graphite. Furthermore, an industrial country, such as the US, who is a large consumer of synthetic graphite, does not have sufficient conversion capability to self-sustain its domestic need. Therefore, converting waste EPS into synthetic graphite increases the domestic production of synthetic graphite and reduces the amount of synthetic graphite that is imported.

Hence, there is a long-felt need for a process for synthesizing synthetic graphite from expanded polystyrene (EPS). Furthermore, there is a need for changing the char yielding behavior of EPS by chemically modifying the EPS and thereafter synthesizing synthetic graphite from the chemically modified EPS.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific processes and structures disclosed herein. The description of a process step or a structure referenced by a numeral in a drawing is applicable to the description of that process step or structure shown by that same numeral in any subsequent drawing herein.

FIG. 1 illustrates a flowchart illustrating a first and second embodiment of the process for synthesizing synthetic graphite from expanded polystyrene (EPS).

FIG. 2A illustrates a schematic experimental setup for synthesizing synthetic graphite from expanded polystyrene by a first embodiment of the process.

FIG. 2B illustrates a schematic experimental setup for synthesizing synthetic graphite from expanded polystyrene by a second embodiment of the process.

FIG. 3B illustrates percent yield of graphite as a function of catalyst concentration for sulfonated expanded polystyrene as obtained under the process of the first embodiment.

FIG. 3B Percent yield of graphite as a function of catalyst concentration for carbonized expanded polystyrene as obtained under the process of the first embodiment.

FIG. 4 illustrates X-ray diffraction (XRD) patterns of the graphite samples synthesized from stabilized expanded polystyrene.

FIG. 5 illustrates X-ray diffraction (XRD) patterns of the graphite samples synthesized from carbonized expanded polystyrene.

FIG. 6 illustrates X-ray diffraction (XRD) patterns of the control samples that were introduced to the same graphitization temperature.

### DETAILED DESCRIPTION OF THE INVENTION

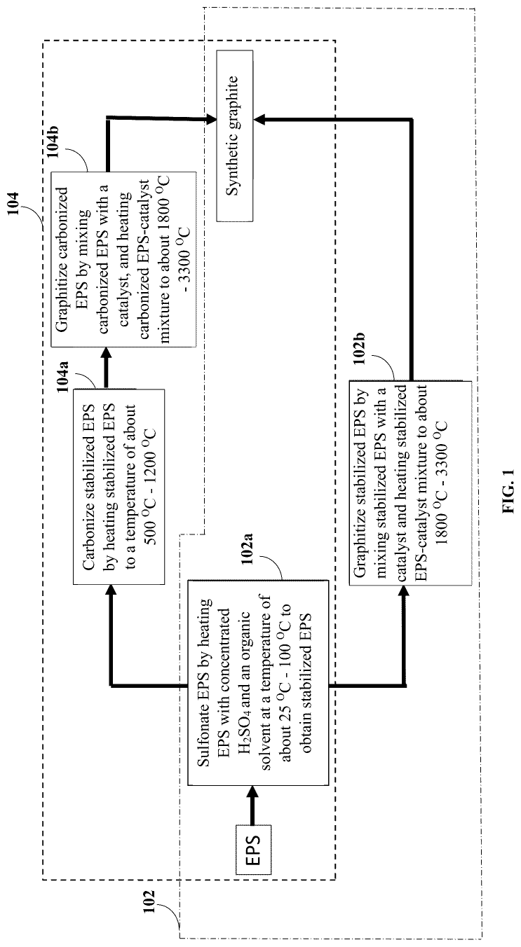

This application discloses two processes for the synthesis of synthetic graphite from expanded polystyrene (EPS). FIG. 1 illustrates a flowchart for the first process herein referred to as the first embodiment 102, and a flow chart for the second process herein referred to as the second embodiment 104 for the process for synthesizing synthetic graphite from expanded polystyrene (EPS). As used herein, expanded polystyrene (EPS) comprises used EPS for example EPS reclaimed from a waste disposal facility, and pristine EPS.

Expanded polystyrene (EPS) does not yield carbon or a char yield when carbonized. As used herein, char yield is percent carbon obtained by thermal decomposition of a carbonaceous material, for example, EPS. In both the first embodiment 102 and the second embodiment 104, to obtain carbon from the EPS, i.e., to obtain a char yield from the EPS, the EPS is stabilized by sulfonating the EPS, which alters the chemical structure of the EPS to yield stabilized EPS which yields carbon or a char yield when carbonized or graphitized. The percent char yield depends on the degree of sulfonation, i.e., the amount of sulfuric acid that reacts per unit mass of EPS during sulfonation. As used herein, stabilization refers to the process of changing the chemical structure and consequently the carbon yielding behavior of the EPS.

In both the first embodiment 102 and the second embodiment 104 of the process, the first step 102a comprises sulfonating the expanded polystyrene (EPS) by dissolving the EPS in an organic solvent and heating the dissolved EPS and residual organic solvent with about 95% to about 98% sulfuric acid at a temperature between about 25° C. to about 100° C. in a heating bath under constant stirring to obtain a sulfonated EPS mixture, herein referred to as stabilized EPS. In an embodiment 95%-98% sulfuric acid is added first to EPS, followed by the addition of a solvent to the EPS-sulfuric acid mixture. The EPS to sulfuric acid ratio is maintained at about 0.1 to 3.0, weight/volume (w/v) during the sulfonation process. In an example, the sulfonation process is continued for about 5 hours at about 50° C. The organic solvents used comprise chloroform, dichloromethane and chlorobenzene. The organic solvent dissolves about 1% weight/volume (w/v) to about 30% (w/v) of expanded polystyrene in about 80% to about 99% by volume of solvent to obtain a solution. The ratio of EPS to organic solvent in the solution is about 1% to about 30% (w/v) and the purity of the solvent is about 80% to about 99% (v/v).

As illustrated in FIG. 1, in the first embodiment 102, the second step 102b is the graphitization of the stabilized expanded polystyrene (EPS). The stabilized EPS is graphitized 102b by mixing the stabilized EPS with a catalyst, for example boron (B), to obtain a stabilized EPS-catalyst mixture, and heating the stabilized EPS-catalyst mixture in a tube furnace 212 at a temperature of between about 1800° C. and about 3300° C., under an inert atmosphere, for example under nitrogen gas (N₂) flow, for about one (1) hour and cooled down to room temperature in about twenty-seven (27) hours, and thereafter cooling the mixture to room temperature over about 10 days under an inert atmosphere, for example under N₂ gas, to yield synthetic graphite 214. The catalyst concentration in the stabilized EPS-catalyst mixture varies from about 0% weight per-weight (w/w) ratio to about 15% (w/w) of the total weight of the precursor. As used herein, the precursor is stabilized EPS in all acid/EPS (A/E) ratios, obtained from the first step 102a in the first embodiment 102.

FIG. 1 also schematically illustrates the synthesis of synthetic graphite by the second embodiment 104. The first step 102a of the second embodiment 104 is identical to the first step 102a of the first embodiment 102. The stabilized EPS obtained from the first step 102a of the second embodiment 104 is carbonized 104a by heating the stabilized EPS in a furnace, under nitrogen (N₂) gas flow, at a temperature of about 500° C. to about 1200° C. at a ramp rate of about 10° C./minute, followed by a dwell time of about 1 minute at the final temperature to obtain carbonized EPS. The carbonized EPS is thereafter graphitized 104b by mixing the carbonized EPS with a catalyst, for example boron, and heating the carbonized EPS-boron mixture in a furnace at about 1800° C. to about 3300° C. for about one (1) hour and cooling down the contents of the furnace to room temperature in about twenty-seven (27) hours to yield synthetic graphite. The catalyst concentration in the carbonized-catalyst mixture varies from 0% weight per weight (w/w) to about 15% (w/w) of the weight of the precursor. The carbonized expanded polystyrene (EPS), in all A/E ratios, as obtained by the second step 104a of carbonization of the stabilized EPS in the second embodiment 104, is used as the precursor in the graphitization step 104b.

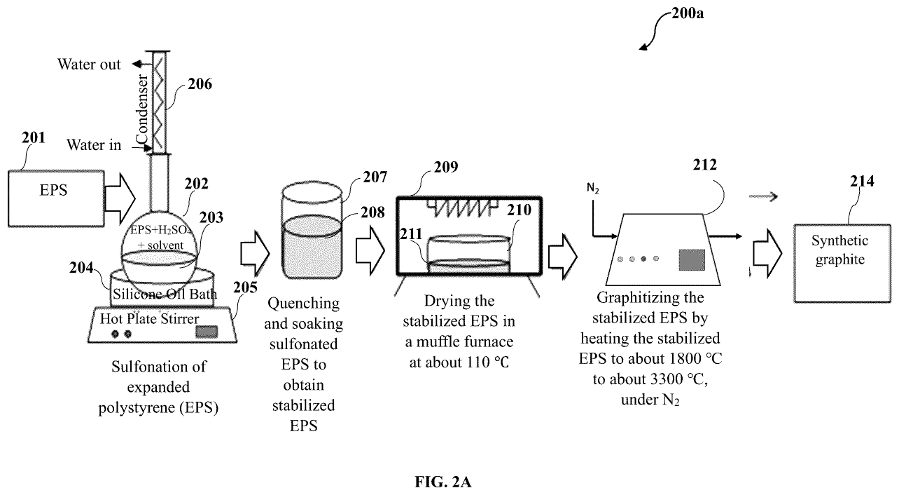

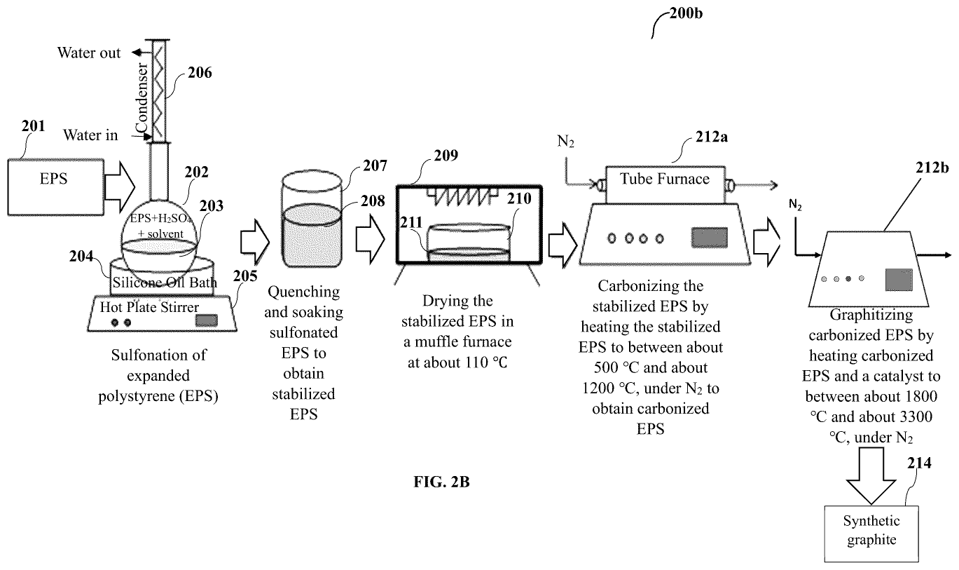

FIG. 2A illustrates a schematic experimental setup 200a for synthesizing synthetic graphite 214 from expanded polystyrene 201 by the first embodiment 102. The first embodiment 102 for synthesizing graphite from expanded polystyrene (EPS) comprises sulfonating 102a expanded polystyrene by dissolving the EPS in an organic solvent to obtain an EPS-solvent mixture, and thereafter heating the mixture with about 95%-98% sulfuric acid to obtain stabilized expanded polystyrene (EPS). About 1-30% w/v of EPS to organic solvent was used to dissolve the EPS. In an embodiment 95%-98% sulfuric acid is added first to EPS, followed by the addition of a solvent to the EPS-sulfuric acid mixture. The sulfonated EPS is quenched in water in a container 207 for about 1-24 hours to obtain stabilized EPS. The stabilized EPS is separated from the water by settling and filtration of the stabilized EPS. The stabilized EPS obtained from the preceding step is dried in a muffle furnace 209 at about 110° C. for about 1 hour to 24 hours. The stabilized EPS is then graphitized 102b by mixing the stabilized EPS with a catalyst and heating the stabilized EPS-catalyst mixture in a furnace 212 to about 1800° C. to 3300° C. for about 1 hour and thereafter cooling down the contents of the furnace 212 to room temperature in about twenty-seven (27) hours under nitrogen (N₂) gas flow to yield synthetic graphite 214. The solvent is selected, for example, from one or more of chloroform, dichloromethane, and chlorobenzene. The catalyst is, for example, boron (B). Examples of other solvents that may be used in the first and second embodiments of the process comprise benzene, toluene, acetone, and tetrahydrofuran. Examples of other catalysts that may be used in the first and second embodiments of the process comprise all the elements of group IVB to VIIB and VIII of the periodic table.

An experimental setup 200a, illustrated in FIG. 2A for the synthesis of synthetic graphite by the first embodiment 102 comprises, for example, a 1000 mL round bottom flask 202 used as a first container, a reflux system 206 implemented as a condenser, a heating bath 204, for example, a silicone heating bath, a hot plate stirrer 205, a second container 207, a muffle furnace 209, and a tube furnace 212. In a typical sulfonation reaction, four (4) batches of about 40.0 grams (g) of expanded polystyrene 201 were dissolved in about 380 mL of solvent, for example, chloroform, contained in four (4) round bottom flasks 202. Thereafter, about 20 mL, about 40 mL, about 80 mL, and about 120 mL of about 95% to about 98% of concentrated sulfuric acid (H₂SO₄) was added in the four round bottom flasks 202 containing the dissolved EPS-solvent mixture under constant stirring by the hot plate stirrer 205. Each round bottom flask 202, one at a time, was introduced to the heating bath 204. A reflux system 206 is fitted on top of each round bottom flask 202 with cold water supply, as shown in FIG. 2A. In an embodiment, reflux is performed with cold tap water. In an example, the sulfonation reaction is continued for about 5 hours at a temperature of about 50° C. In both the first embodiment 102 and the second embodiment 104 of the synthesis of synthetic graphite from EPS, there is no definite “completion” point of the sulfonation reaction. At a certain time, when the degree of sulfonation is too high, the reaction mixture becomes too viscous and the stirring in the flask 203 stops. The sulfonation reaction is stopped at a predetermined time before that point; it was found that about 5 hours is an optimal time for stopping the sulfonation reaction. The degree of sulfonation depends on the time and temperature of the sulfonation reaction.

In the first embodiment 102, at the completion of the sulfonation reaction in flask 203, illustrated in FIG. 2A, each of the reaction mixtures comprising the sulfonated EPS in the four round bottom flasks was quenched in deionized (DI) water in another container 207, soaked overnight, and then the solid matter in the stabilized EPS 211 was separated by settling and filtration to obtain stabilized EPS. The filtered, separated stabilized EPS 211 is placed in another container 210 and introduced into the muffle furnace 209. The filtered and separated solid matter of the stabilized EPS 208 was dried at a temperature between about 100° C. and about 110° C. for about 15 minutes to about 12 hours in a muffle furnace 209 to obtain dried stabilized EPS. The stabilized EPS that is synthesized with about 20 mL, about 40 mL, about 80 mL, and about 120 mL of about 95% to about 98% of concentrated sulfuric acid is termed in accordance with the ratio of sulfuric acid to EPS, i.e., A/E=0.5 mL/g, A/E=1 mL/g, A/E=2 mL/g, and A/E=3 mL/g. A/E stands for acid/expanded polystyrene (EPS) ratio. The stabilized EPS was characterized with thermogravimetric analysis (TGA) up to 1000° C. temperature, under nitrogen (N₂) gas flow. The stabilized EPS is then graphitized 102b by mixing the stabilized EPS with a catalyst and heating the stabilized EPS—catalyst mixture in a furnace 212 to about 1800° C. to 3300° C. for about 1 hour and thereafter cooling down the contents of the furnace 212 to room temperature in about twenty-seven (27) hours under nitrogen (N₂) gas flow to yield synthetic graphite 214.

FIG. 2B illustrates a schematic experimental setup 200b for synthesizing synthetic graphite 214 from expanded polystyrene (EPS) 201 by the second embodiment 104. The second embodiment 102 for synthesizing synthetic graphite from expanded polystyrene (EPS) comprises sulfonating 102a expanded polystyrene by dissolving the EPS in an organic solvent to obtain an EPS—solvent mixture, and thereafter heating the mixture with about 95% to 98% sulfuric acid to obtain stabilized expanded polystyrene (EPS). In an embodiment 95%-98% sulfuric acid is added first to EPS, followed by the addition of a solvent to the EPS-sulfuric acid mixture. The weight percent of catalyst to carbonized EPS is about 5% weight-per-weight (w/w) to about 15% (w/w) of the carbonized EPS.

As illustrated in FIG. 2B for the synthesis of synthetic graphite by the second embodiment 104, the sulfonated EPS is thereafter quenched in deionized water 208 in a container 207, and soaked overnight. The excess deionized water is separated from the solid matter in the container 207 by settling and filtration to obtain stabilized EPS 211. The stabilized EPS 211 is transferred to another container 210 and dried in a muffle furnace 209 at about 110° C. The dried, stabilized EPS 211 is thereafter carbonized 104a by heating the stabilized EPS in a tube furnace 212a under nitrogen flow at a temperature between about 500° C. and 1200° C. to obtain carbonized EPS. The carbonized EPS is cooled under nitrogen flow to room temperature. The cooled, carbonized EPS is graphitized 104b by mixing the carbonized EPS with a catalyst, for example boron, and heating the carbonized EPS—catalyst mixture in a furnace to between about 1800° C. to 3300° C. under nitrogen flow for about one (1) hour and then cooling down the contents of the furnace 212b to the room temperature in about twenty-seven (27) hours to obtain synthetic graphite.

In the second embodiment 104, in an example, about 60 grams (g) of stabilized EPS (for example, prepared with acid/expanded polystyrene (EPS) ratio A/E=1.0 mL/g) was loaded into an alumina crucible and then the crucible was introduced to a quartz tube of the tube furnace 212a, for example, a Mellen Tube furnace, and heated to about 800° C. at a ramp rate of about 10° C./min followed by a dwell time of about 1 minute at the final heated temperature. The mixture in the tube furnace 212a is then cooled to room temperature under nitrogen gas flow to yield carbonized EPS.

In both the first embodiment 102 and the second embodiment 104, either boric acid (H₃BO₃) or amorphous boron powder in all ratios was used as the source of boron. In an embodiment, the concentration of boric acid (H₃BO₃) or amorphous boron powder in the mixture varies from about 5% weight-per-weight (w/w) to about 15% (w/w) of the total weight of the precursor. The stabilized expanded polystyrene (EPS) in all A/E ratios, as obtained by the sulfonation 102a step is used as the precursor in the graphitization 102b step in the first embodiment 102. The stabilized EPS in all A/E ratios as obtained by the sulfonation 102a step is used in the carbonization 104a step in the second embodiment 104 of the process. Varying degree of graphitization is induced by varying the concentration of the catalyst in the graphitization 102b step of the first embodiment 102, and by varying the concentration of the catalyst in the graphitization 104b step of the second embodiment 104. In an embodiment, the catalyst concentration in the mixture varied from about 0% weight-per-weight (w/w) to about 15% (w/w) of the total weight of the precursor. In the first embodiment 102, the precursor for the graphitization 102b step is stabilized EPS. In the second embodiment 104, the precursor for the graphitization 104b step is carbonized EPS. In another embodiment, the catalyst concentration in the stabilized EPS-catalyst mixture in the graphitization 102b step in the first embodiment 102, and in the carbonized EPS—catalyst mixture in the graphitization 104b step of the second embodiment 104 is increased to more than 15% (w/w) of the precursor. For the catalyst that was mixed with stabilized expanded polystyrene (EPS) (A/E=1 mL/g), as per the first embodiment of the process, the percent ratio was based on the char yield that was obtained in the thermogravimetric analysis (TGA). The carbonized expanded polystyrene (EPS) that was obtained from A/E=1 mL/g, as per the second embodiment, is termed as 1 mL/g-C. Table 1, below, shows the different amounts of stabilized EPS that were mixed with the catalyst, as per the first embodiment 102.

TABLE 1
Type and Amount of catalyst to produce
graphite from stabilized EPS

| | | | Initial | | |
|---|---|---|---|---|---|
| | Graphite | | Catalyst | Precursor | Catalyst |
| | sample | Catalyst | concen- | amount | amount |
| Precursor | name | type | tration | (g) | (g) |
| A/E: | 1 mL/g- | Boric | 5% B from | 5.006 | 0.4085 |
| 1 mL/g | 5BA | Acid | boric acid | | |
| | 1 mL/g- | | 10% B from | 1.15 | 0.187 |
| | 10BA | | boric acid | | |
| | 1 mL/g- | | 15% B from | 1.154 | 0.284 |
| | 15BA | | boric acid | | |
| | 1 mL/g- | Amorphous | 5% B from | 5.005 | 0.0762 |
| | 5B | hours | Amorphous | | |
| | | Boron | Boron | | |
| | | Powder | Powder | | |
| | 1 mL/g- | | 10% B from | 1.15 | 0.0348 |
| | 10B | | Amorphous | | |
| | | | Boron | | |
| | | | Powder | | |
| | 1 mL/g- | | 15% B from | 1.152 | 0.0530 |
| | 15B | | Amorphous | | |
| | | | Boron | | |
| | | | Powder | | |

Table 2, shown below, shows the different amounts of carbonized EPS that were mixed with the catalyst, as per the second embodiment.

TABLE 2
Type and Amount of catalyst to produce
graphite from carbonized EPS

| | | | Initial | | |
|---|---|---|---|---|---|
| | Graphite | | Catalyst | Precursor | Catalyst |
| | sample | Catalyst | concen- | amount | amount |
| Precursor | name | type | tration | (g) | (g) |
| A/E: | 1 mL/g-C- | Boric | 5% B from | 4.12 | 1.178 |
| 1 mL/g-C | 5BA | Acid | boric acid | | |
| | 1 mL/g-C- | | 10% B from | 3.46 | 1.973 |
| | 10BA | | boric acid | | |
| | 1 mL/g-C- | | 15% B from | 3.6 | 3.11 |
| | 15BA | | boric acid | | |
| | 1 mL/g-C- | Amorphous | 5% B from | 3.6 | 0.1892 |
| | 5B | hours | Amorphous | | |
| | | Boron | Boron | | |
| | | Powder | Powder | | |
| | 1 mL/g-C- | | 10% B from | 3.6 | 0.3791′ |
| | 10B | | Amorphous | | |
| | | | Boron | | |
| | | | Powder | | |
| | 1 mL/g-C- | | 15% B from | 3.6 | 0.5683 |
| | 15B | | Amorphous | | |
| | | | Boron | | |
| | | | Powder | | |

For the preparation of all the samples for the graphitization step, the catalysts were mixed with the precursor by grinding in a mortar and pestle for about 20 minutes. As disclosed, the precursor is either stabilized EPS or carbonized EPS. The mixtures of catalysts and the precursors can be graphitized by heating the mixtures in a temperature range between about 1800° C. and about 3300° C. in an inert atmosphere.

In the first embodiment 102, the precursor for the graphitization 102b step is stabilized EPS. In the second embodiment 104, the precursor for the graphitization 104b step is carbonized EPS. In a typical run, these precursor-catalyst mixtures are loaded into crucibles made of commercial graphite blocks, in a tube furnace, for example, 212 or 212b. In an example, the tube furnace with the precursor-catalyst mixture is heated to a temperature of about 3300° C. for a predetermined time period of about 27 hours. The tube furnace is maintained at this temperature for about one hour, and then the tube furnace is cooled to room temperature over about 10 days to yield synthetic graphite. All the heating and cooling operations are performed under nitrogen (N₂) gas flow.

Two control experiments were performed to understand the role of the catalyst. In one experiment, graphitization experiment on 1 mL/g-C was performed in the same fashion disclosed above, but without any catalyst. In another experiment, boric acid with 1 mL/g-C was mixed with the equivalent boron content of 0.5 wt. % and the same graphitization experiment was performed.

All the graphitized samples after heat treatment were characterized without any purification or treatment processes. X-ray diffraction (XRD) was employed as the primary form of characterization and the necessary graphitization parameters were calculated from the X-ray diffraction (XRD) peaks. X-ray diffraction (XRD) data was obtained in Miniflex II instrument manufactured by Rigaku Corporation headquartered in Tokyo, Japan, and the data were analyzed in the built-in instrument of the Miniflex II instrument. The porosity of all the graphite samples including BET (Brunauer, Emmett and Teller) surface area and the total pore volume were calculated by nitrogen (N₂) gas adsorption at 77 K temperature in Autosorb iQ instrument that can analyze any Gas surface area and porosity. Autosorb iQ is manufactured by Quantachrome Corporation headquartered in Graz, Austria. Autosorb iQ is an automated gas sorption analyzer that measures the specific surface and volume of solids.

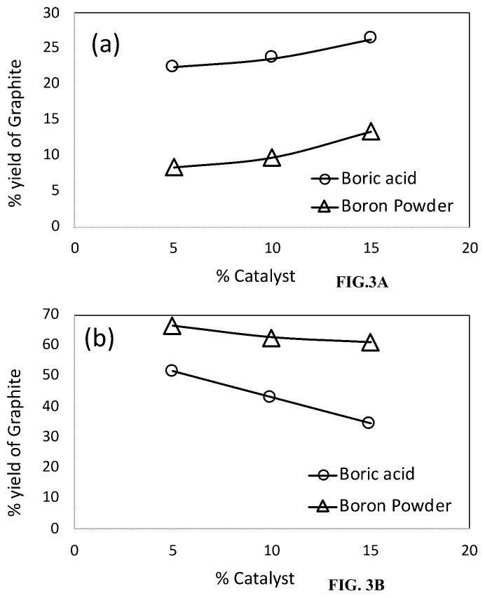

The percent yield of graphite as a function of the catalyst concentrations is illustrated in FIGS. 3A and 3B for graphite samples produced from stabilized and carbonized EPS respectively. The overall yield of graphite was higher for carbonized expanded polystyrene (EPS), obtained in the second embodiment of the process than that of stabilized expanded polystyrene (EPS), obtained in the first embodiment of the process. This is owing to higher carbon content of the carbonized expanded polystyrene (EPS). As observed in FIGS. 3A and 3B, stabilized and carbonized expanded polystyrene (EPS) demonstrated two opposite trends of catalyst concentrations that contributed to the graphite yields. For stabilized expanded polystyrene (EPS), boric acid contributed to higher graphite yield unlike carbonized expanded polystyrene (EPS) that showed higher graphite yields with amorphous boron powder. In addition, for stabilized expanded polystyrene (EPS), graphite yield increased monotonically with the increase in the concentration of boric acid and amorphous boron powder. For carbonized expanded polystyrene (EPS), the graphite yield decreased with the increase in concentration of both type of catalysts. The highest graphite yield was 26.38% with boric acid for stabilized expanded polystyrene (EPS), where the same yield was 66.29% with amorphous boron powder for carbonized expanded polystyrene (EPS).

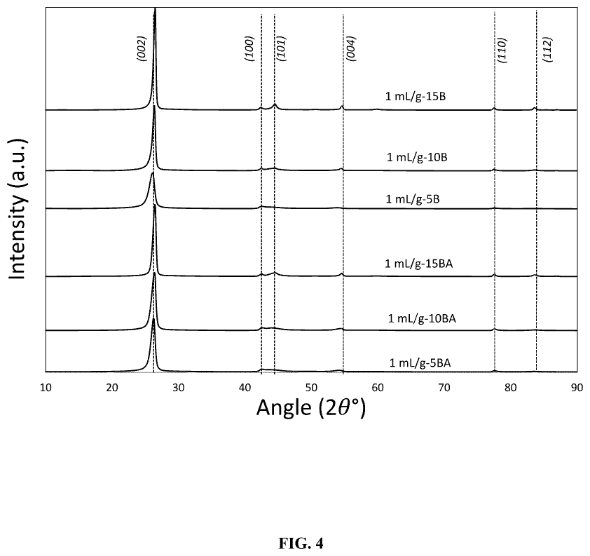

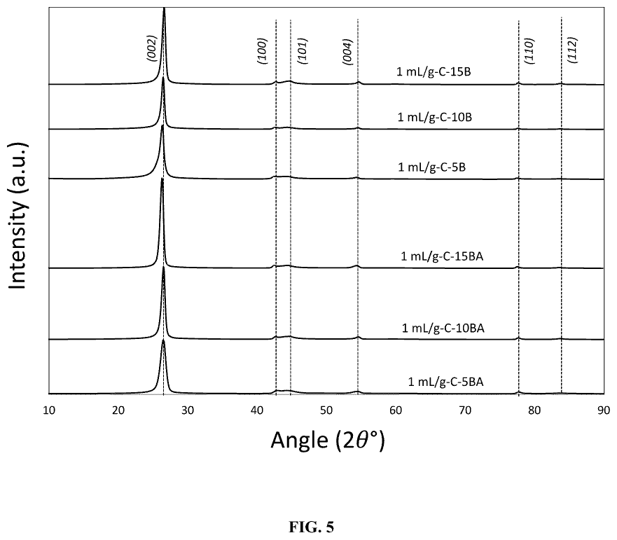

The X-ray diffraction (XRD) peaks of the graphite that were synthesized from the stabilized expanded polystyrene (EPS) are shown in FIG. 4, whereas the X-ray diffraction (XRD) of the graphite that were synthesized from the carbonized expanded polystyrene (EPS) are shown in FIG. 5. As observed in these figures, all the X-ray diffraction (XRD) patterns have the sharp characteristic peak around the angle of 2θ=26.5° that corresponds to the stacking of graphene layers in vertical (“c”) axis, which is referred to as the (002) reflection plane of graphite crystals. This peak is the key signature of all the graphite crystals. The X-ray diffraction (XRD) patterns also have a few small peaks at the angle of around 42.5, 44.4, 54.3, 77.6, and 83.9°, corresponding to the reflection points of (100), (101), (004), (110), and (112) reflection planes of graphite crystals. The two peaks associated with (101) and (112) reflection planes signifies that these are Bernal (AB stacked) Graphite.

Furthermore, the graphite crystal parameters from the X-ray diffraction (XRD) data was calculated. For each of the X-ray diffraction (XRD) patterns, the precise angle of (002) reflection point (20), corresponding full width at half maximum (FWHM), and d-spacing (d002) were directly calculated from the built-in software of the X-ray diffraction (XRD) instrument. The stacking height (L_c), lateral size (L_a), were calculated by the formula:

$${L}_{c} = \frac{k λ}{β cos θ} \qquad ( 1 )$$

$${L}_{a} = \frac{1.84 λ}{β cos θ} \qquad ( 2 )$$

where, k is crystallite shape factor, which equals to 0.94 for polycrystalline graphite, β is the FWHM of the corresponding XRD peak, and θ is the corresponding scattering angle, and λ is the wavelength of the incident x-ray. Percent graphitization of degree of graphitization was estimated from the interplanar spacing in vertical axis of graphite under the assumption that d002=0.356 for no graphitization (i.e., percent graphitization=0) and d002-0.3354 for perfect graphitization (i.e., percent graphitization=100))8. The percent graphitization is calculated by the formula:

$$\% Graphitization = \frac{0.356 - {d}_{002}}{0.356 - 0.3354} \times 100 \% \qquad ( 3 )$$

The graphitization parameters are illustrated in table 3 and table 4, shown below, for graphite samples that were produced from stabilized and carbonized expanded polystyrene (EPS).

TABLE 3
Crystalline properties of graphite synthesized
from the stabilized expanded polystyrene (EPS).

| Graphite | | | | |
|---|---|---|---|---|
| sample | d₀₀₂ | Lₐ | L_{c} | % |
| name | (nm) | (nm) | (nm) | Graphitization |
| 1 mL/g- | 0.3363 | 18.30 | 9.35 | 95.30 |
| 5BA | | | | |
| 1 mL/g- | 0.3359 | 28.61 | 14.61 | 97.55 |
| 10BA | | | | |
| 1 mL/g- | 0.3386 | 29.47 | 15.05 | 84.00 |
| 15BA | | | | |
| 1 mL/g- | 0.3379 | 25.13 | 12.83 | 87.62 |
| 5B | | | | |
| 1 mL/g- | 0.3366 | 33.58 | 17.15 | 94.02 |
| 10B | | | | |
| 1 mL/g- | 0.3349 | 29.57 | 15.10 | 102.38 |
| 15B | | | | |

TABLE 4
Crystalline properties of graphite synthesized
from the carbonized expanded polystyrene (EPS)

| Graphite | | | | |
|---|---|---|---|---|
| sample | d₀₀₂ | Lₐ | L_{c} | % |
| name | (nm) | (nm) | (nm) | Graphitization |
| 1 mL/g- | 0.3392 | 23.01 | 11.75 | 81.45 |
| C-5BA | | | | |
| 1 mL/g- | 0.3374 | 22.49 | 11.49 | 90.04 |
| C-10BA | | | | |
| 1 mL/g- | 0.3366 | 30.57 | 15.61 | 93.93 |
| C-15BA | | | | |
| 1 mL/g- | 0.3410 | 17.97 | 9.18 | 72.57 |
| C-5B | | | | |
| 1 mL/g- | 0.3379 | 33.64 | 17.18 | 87.57 |
| C-10B | | | | |
| 1 mL/g- | 0.3363 | 41.31 | 21.10 | 95.53 |
| C-15B | | | | |

As observed in tables 3 and 4, there was a minimal increase in d-spacings (d₀₀₂, nm) with the increase in catalyst concentration for stabilized and carbonized expanded polystyrene (EPS). With the exception of 10% boric acid, the stacking height and lateral size of the graphite crystallites increased with the increase in catalyst concentration. As observed in table 3, the percent graphitization of 1 mL/g-15B was calculated to be more than 100%. These anomalous results are caused by a d-spacing (d₀₀₂) measured at 0.3349 nm for this graphite, which is smaller than the d-spacing of ideal graphite (0.3354 nm) that was incorporated in the calculation. It needs to be noted that the XRD peaks were measured first, then the graphitization parameters were calculated for a commercially available synthetic graphite for comparison purposes. The commercially available synthetic graphite was purchased from Sigma Aldrich, catalog no. 282863-25G. This commercial graphite has d-spacing (d₀₀₂)=0.3389 nm, lateral size (Lₐ)=33.06 nm, stacking height (L_{c})=16.89 nm, % Graphitization=82.64. Based on these numbers, it was found that the graphite synthesized using the embodiments of the process described herein is equivalent or better than this reference of commercial synthetic graphite.

The porosity of graphite samples, including BET (Brunauer, Emmett and Teller) surface area and total pore volume are given in tables 5 and 6. As observed in these tables, the porosity of all the graphite samples is very low and there is no specific trend of porosity with respect to the synthesis conditions. Sample 1 mL/g-5B is found to be zero, whereas it exhibits a total pore volume of 0.029 cm³/g, which is similar to other graphite samples. Such observation is supported by the fact that the pore volume is caused by micropores that are slightly too large to be included in the calculation of the BET surface.

TABLE 5
Porosity of graphite synthesized from the stabilized EPS

| | Graphite sample name | | | | | |
|---|---|---|---|---|---|---|
| | 1 mL/g- | 1 mL/g- | 1 mL/g- | 1 mL/g- | 1 mL/g- | 1 mL/g- |
| | 5BA | 10BA | 51BA | 5B | 10B | 15B |
| BET | 4.91 | 11.85 | 4.36 | 0 | 4.47 | 7.38 |
| specific | | | | | | |
| surface | | | | | | |
| area (m²/g) | | | | | | |
| Total Pore | 0.025 | 0.085 | 0.025 | 0.029 | 0.028 | 0.033 |
| volume | | | | | | |
| (cm³/g) | | | | | | |

TABLE 6
Porosity of graphite synthesized from carbonized EPS

| | Graphite sample name | | | | | |
|---|---|---|---|---|---|---|
| | 1 mL/g- | 1 mL/g- | 1 mL/g- | 1 mL/g- | 1 mL/g- | 1 mL/g- |
| | C-5BA | C-10BA | C-51BA | C-5B | C-10B | C-15B |
| BET specific | 6.03 | 6.51 | 2.88 | 8.4 | 6.91 | 1.17 |
| surface area | | | | | | |
| (m²/g) | | | | | | |
| Total Pore | 0.019 | 0.028 | 0.029 | 0.02 | 0.025 | 0.020 |
| volume | | | | | | |
| (cm³/g) | | | | | | |

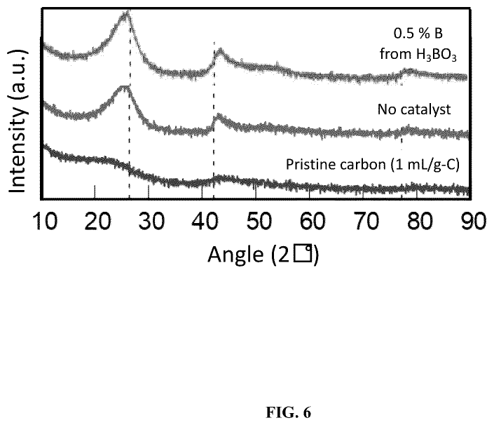

FIG. 6 illustrates X-ray diffraction (XRD) patterns of the control samples that were introduced to the same graphitization temperature. In order to examine the control experiments, the XRD patterns of the three samples, shown in FIG. 6, includes pristine carbon (1 mL/g-C), pristine carbon that was heat treated at 3300° C. and the mixture of pristine carbon with 0.5% boron from boric acid. All three control samples underwent the same heat treatment. As characterized by very broad peaks in those figures, the pristine carbon (1 mL/g-C) did not convert to graphite. This result is due to an absence of a catalyst. Analysis of XRD revealed that pristine carbon (1 mL/g-C) has the crystalline parameters of d₀₀₂=0.372 nm, Lₐ=0.6 nm, L_{c}=0.4 nm; upon heating to 3300° C., a minor change occurred in the crystalline parameters, and those changed to d₀₀₂=0.344 nm, Lₐ=4.1 nm, L_{c}=2.1 nm. When sample was heated under the same condition, but with 0.5 wt. % boron from boric acid, minor graphitic phases appeared in the sample with d₀₀₂=0.337 nm, Lₐ=3.4 nm, L_{c}=33.4 nm. This observation suggests the carbon obtained from stabilized EPS (1 mL/g-C) is a “non-graphitizing” carbon and hence cannot be graphitized without a catalyst. 0.5% catalyst (boron from boric acid) could only lead to the formation of marginal graphitic phases. However, the increase in catalyst concentration (5-15%) completely converts the material into graphite, as observed in tables 3-4 and FIGS. 4 and 5.

The foregoing examples and illustrative implementations of various embodiments have been provided merely for explanation and are in no way to be construed as limiting the embodiments of the process disclosed herein. While the embodiments of the process have been described with reference to various illustrative drawings and techniques, it is understood that the words, which have been used herein, are words of description and illustration, rather than words of limitation. Furthermore, although the embodiments of the process have been described herein with reference to particular means, materials, techniques, and implementations, the embodiments of the process herein are not intended to be limited to the particulars disclosed herein; rather, the embodiments of the process extend to all functionally equivalent structures, processes and uses, such as are within the scope of the appended claims. It will be understood by those skilled in the art, having the benefit of the teachings of this specification, that the embodiments of the process disclosed herein are capable of modifications and other embodiments of the process may be effected and changes may be made thereto, without departing from the scope and spirit of the embodiments of the process disclosed herein.

We claim:

1. A process for synthesizing synthetic graphite from expanded polystyrene, the process comprising:
(a) sulfonating the expanded polystyrene with a solvent and sulfuric acid to obtain stabilized expanded polystyrene; and
(b) graphitizing the stabilized expanded polystyrene using a catalyst to obtain synthetic graphite, comprising:
mixing the stabilized expanded polystyrene and the catalyst to obtain a mixture and heating the mixture in a temperature range between about 1800° C. and about 3300° C. in an inert atmosphere.

2. The process of claim 1, wherein the solvent is one of chloroform, dichloromethane, and chlorobenzene, and wherein the catalyst is boron.

3. The process of claim 1, wherein step (a) comprises:
(i) dissolving about 1% to about 30% by weight per volume of the expanded polystyrene in about 80% to about 99% by volume of solvent to obtain a solution;
(ii) adding about 95% to about 98% by weight of concentrated sulfuric acid to the solution to obtain a mixture;
(iii) heating the mixture to a predetermined temperature in a heating bath under constant stirring for a predetermined time period;
(iv) adding water to the heated mixture to coagulate the heated mixture for a predetermined time interval and then separating the water by settling and filtration; and
(v) drying the mixture in an oven at a predetermined temperature to obtain the sulfonated expanded polystyrene.

4. The process of claim 3, wherein the mixture is heated to about 50° C., wherein the predetermined time period for heating the mixture is about 5 hours, and wherein the predetermined temperature for drying the mixture in the oven is about 100° C.

5. The process of claim 3, further comprising varying the ratio of concentrated sulfuric acid (mL) to EPS (g) during the course of sulfonation is 0.5 mL/g to 3 mL/g.

6. The process of claim 3, wherein the heating bath is a silicone oil bath.

7. The process of claim 3, wherein the predetermined time interval for coagulating the heated mixture is about 15 minutes to about 15 hours.

8. The process of claim 1, further comprising one of:
varying degree of graphitization by varying concentration of the catalyst between 0 to 15% (w/w) of the equivalent char yield of the precursor; and
varying degree of graphitization by increasing the concentration of the catalyst to more than 15% (w/w) of the total weight of the mixture.

9. A process for synthesizing synthetic graphite from expanded polystyrene, the process comprising:
(a) sulfonating the expanded polystyrene with sulfuric acid in the presence of a solvent to obtain stabilized expanded polystyrene;
(b) carbonizing the stabilized expanded polystyrene at a predetermined elevated temperature in a furnace to obtain carbonized expanded polystyrene, and cooling the carbonized expanded polystyrene to room temperature; and
(c) graphitizing the carbonized expanded polystyrene using a catalyst to obtain synthetic graphite, comprising:
mixing the carbonized expanded polystyrene and the catalyst to obtain a mixture and heating the mixture in a temperature range between about 1800° C. and about 3300° C. in an inert atmosphere to obtain synthetic graphite.

10. The process of claim 9, wherein the predetermined elevated temperature for carbonizing the stabilized expanded polystyrene is about 800° C., with a ramp rate of about 10° C. per minute followed by dwell time of 1 minute at the final temperature.

11. The process of claim 9, wherein carbonizing the stabilized expanded polystyrene comprises heating the stabilized expanded polystyrene in the furnace at a temperature between about 500° C. and 1200° C. under nitrogen gas flow, and cooling the heated stabilized expanded polystyrene under nitrogen gas flow to room temperature to obtain carbonized expanded polystyrene.

12. The process of claim 9, wherein the solvent is one of chloroform, dichloromethane, and chlorobenzene, and wherein the catalyst is boron.

13. The process of claim 9, wherein step (a) comprises:
(vi) dissolving about 1% to about 30% by weight per volume of the expanded polystyrene in about 80% to about 99% by volume of solvent to obtain a solution;
(vii) adding about 95% to about 98% by weight of concentrated sulfuric acid to the solution to obtain a mixture;
(viii) heating the mixture to a predetermined temperature in a heating bath under constant stirring for a predetermined time period;
(ix) adding water to the heated mixture to coagulate the heated mixture overnight and then separating the water by settling and filtration; and
(x) drying the mixture in an oven at a predetermined temperature to obtain the sulfonated expanded polystyrene.

14. The process of claim 13, wherein the predetermined temperature for heating the mixture is about 50° C., wherein the predetermined time period for heating the mixture is about 5 hours, and wherein the predetermined temperature for drying the mixture in the oven is about 100° C.

15. The process of claim 13, further comprises varying the ratio of concentrated sulfuric acid (mL) to EPS (g) during the course of sulfonation from 0.5 mL/g to 3 mL/g.

16. The process of claim 9, further comprises one of:
varying degree of graphitization by varying concentration of the catalyst between 0 to 15% (w/w) of the total weight of the precursor; and
varying degree of graphitization by increasing the concentration of the catalyst to more than 15% (w/w) of the total weight of the mixture.
